(19) United States
(12) Patent Application Publication
(10) Pub. No.: US 2007/0227207 A1
(43) Pub. Date: Oct. 4, 2007

(54) Motor-Actuated Lock for Vehicle Doors or Flaps

(76) Inventors: Dirk Ruppach, Bochum (DE); Hans-Gunter Kaiser, Wuppertal (DE); Lothar Schemberg, Essen (DE)

Correspondence Address: FRIEDRICH KUEFFNER, 317 MADISON AVENUE, SUITE 910, NEW YORK, NY, 10017, US

(21) Appl. No.: 11/597,344

(22) PCT Filed: Apr. 30, 2005
(86) PCT No.: PCT/EP05/04723

§ 371 Date: Nov. 22, 2006

(30) Foreign Application Priority Data
May 25, 2004 (DE) 10 2004 026 065.6

(51) Int. Cl. B60R 25/00

(52) U.S. Cl. 70/237

(57) ABSTRACT

A motor-actuated lock for vehicles comprises a lock housing (11) provided with lock elements, and a motor (20) which, in turn, comprises a motor housing (21). The lock housing (11) has a connection point (12) for the motor housing (21), said motor housing being fixed to the lock housing at this point by fixing means (30). The aim of the invention is to develop a lock provided with a quiet motor (20). To this end, elastic elements (40) are arranged on the connection point (12) between the motor housing (21) and the lock housing (11). The fixing means (30) also engage with said elastic elements (40).

The invention pertains to a lock of the type indicated in the introductory clause of claim 1. A lock of this type is known from DE 102 33 781 A1. A lock housing for the elements of the lock has a connection point for the motor housing of a motor, which is designed as an electric motor. The motor housing is attached by fastening means to the lock housing, whereas the lock housing is attached to the door or hatch of the vehicle.

When the motor is in operation, vibrations occur in the motor housing. Such vibrations can occur when the elements of the motor are not balanced properly. These vibrations generate noise, which is transmitted via the lock housing to the door or hatch. The door or hatch acts as a resonator,-which amplifies the noise of the motor. This amplified motor noise is very annoying.

One possible way of minimizing the noise of the motor is to install the motor a certain distance away from the lock housing and to bridge the gap with a flexible shaft. This measure is complicated and can be implemented only with difficulty. Above all, this measure requires a large amount of space, which is thus lost to other uses in the vehicle.

A motor-operated actuating unit for a vehicle is known from Patent Abstracts of Japan, Vol. 2000, No. 06. A housing part of a transmission gear, which belongs to a motor housing, is mounted by means of a fastening bolt to a base plate. The base plate is attached in turn to a door. An elastic element, on which the head of the fastening bolt acts, is located at an opening in the base plate. This elastic element is intended to prevent the vibrations of the motor from being transmitted to the base plate. It is awkward and time-consuming to insert the elastic element in the hole in the base plate before inserting the fastening bolt.

The invention is based on the task of developing a motor-actuated lock with a quiet-running motor as set forth in claim 1. This is achieved according to the invention by the measures listed in the characterizing clause of claim 1, to which the following special meaning attaches.

Elastic elements, which are a component of a profiled structure consisting of elastomeric material, to be called in brief in the following as the “elastomer structure”, are provided at all of the connection points between the motor housing and the lock housing. The elastomer structure with all its elastic elements is designed as a single part and can be preassembled with the motor housing. The elastomer structure and the motor housing then form a single structural unit, which can be handled as a whole. During the assembly step, there is therefore no longer any need to insert separate elastic elements between the motor housing and the lock housing when attaching the components to each other. This facilitates the mounting of the motor on the lock housing.

For the positioning of this unit on the lock housing, it is recommended that the profilings mentioned in claim 5 be used. As can be derived from claim 6, these can consist of locating pins on the elastomer structure of the unit on the one side and of receptacles in the lock housing. After the unit has been attached to the lock housing and the locating pins are thus engaged in the receptacles in the lock housing, the pins ensure that there is a certain axial distance between the elastomer structure on the one side and the lock housing on the other side. This provides additional damping in the connection plane between the motor housing and the lock housing.

It is advantageous, according to claim 7, for fastening means, each of which consists of a bushing and a fastening pin passing through the interior of the bushing, to pass through openings in a flange of the motor housing in such a way that the elastomer structure or its elastomeric elements are located between the fastening means and the housing. The openings in the flange of the motor housing have lateral clearance with respect to the bushing of the fastening means. According to claim 10, the length of the bushing prevents the occurrence of a clamping action on the elastomer structure.

Additional measures and advantages of the invention can be derived from the claims, from the following description, and from the drawings. An exemplary embodiment of the invention is illustrated in the drawings, which provide various views:

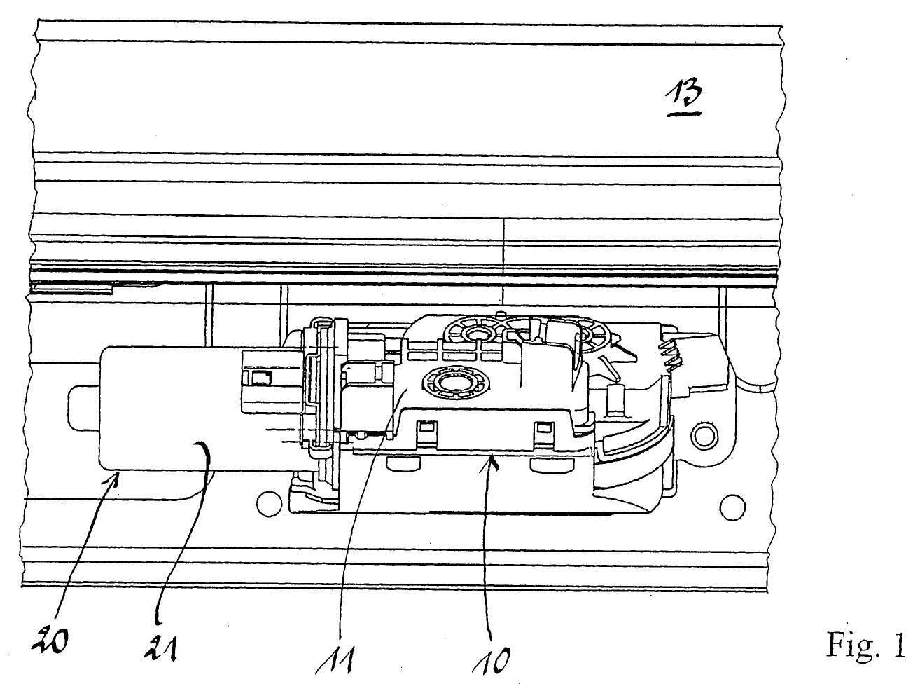

FIG. 1 shows a perspective view of a lock with a motor attached to it, after the lock has been attached to the inside surface of a rear hatch of a vehicle, only a section of which is shown;

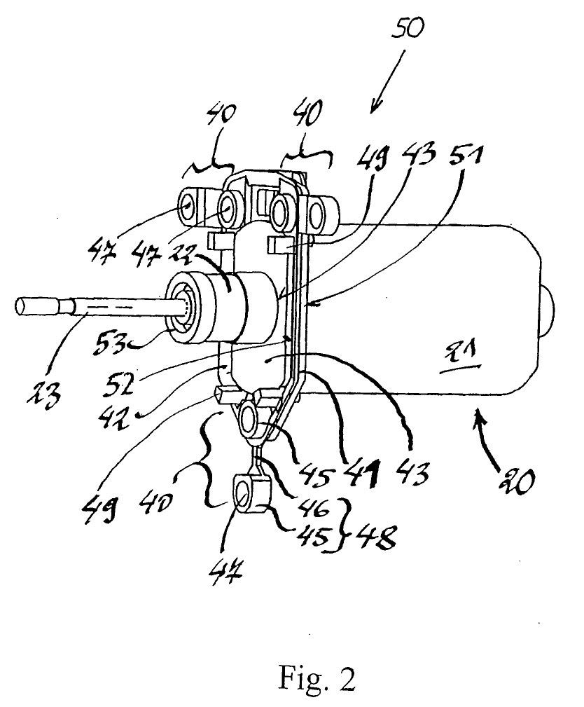

FIG. 2 shows a perspective view of a preassembled unit consisting of the motor and an elastomeric structure;

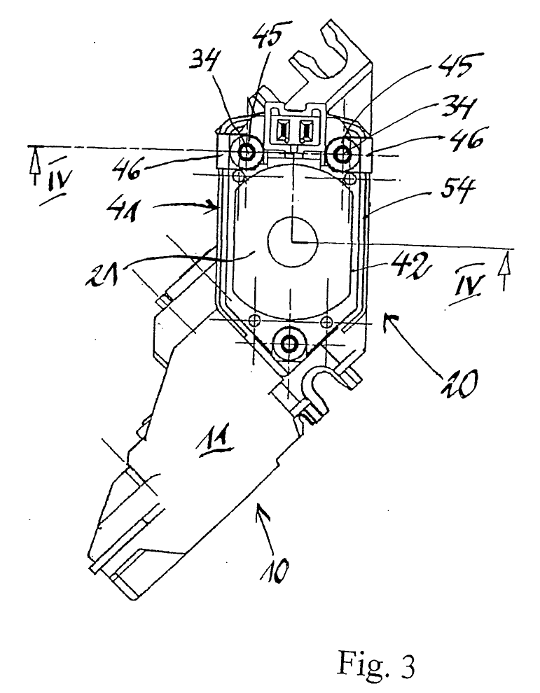

FIG. 3 shows a side view of a completely installed unit consisting of the motor and the lock, where the rear hatch, on which the lock is mounted, has been omitted; and

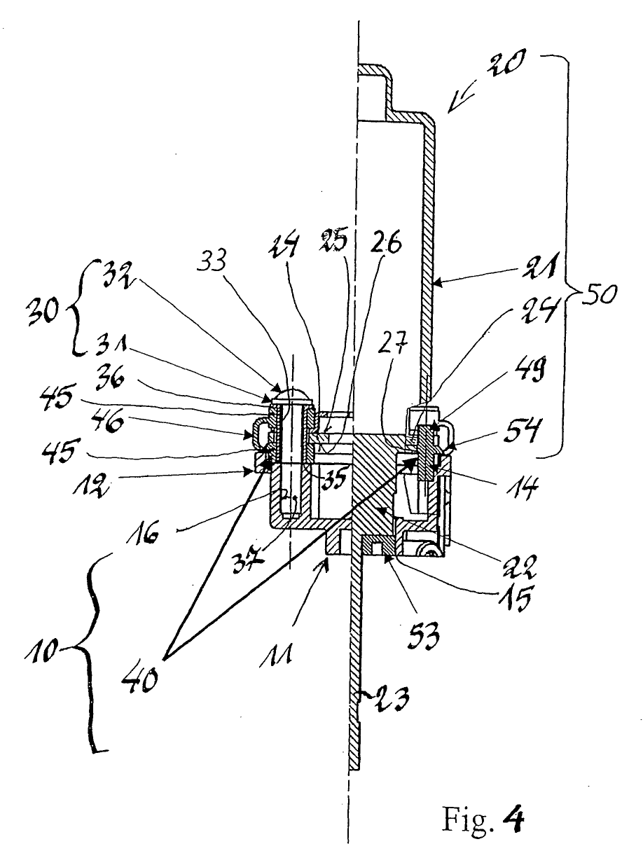

FIG. 4 shows an axial cross section through the assembly of FIG. 3 in the two offset planes defined by lines IV-IV in FIG. 3.

The object of the invention is a special type of connection between a lock 10 and a motor 20. In the present case, the lock is attached to the rear hatch 13 of a vehicle. The elements of the lock are installed in a lock housing 11. The motor 20 includes a motor housing 21, to which a connection point 12 on the lock housing 11 is assigned. At the connection point 40 there is an elastic element 40 between the motor housing 21 and the lock housing 11. The fastening means 30 act on this element. [The] elastic element 40 is first attached to the motor housing 21, and the two components thus create a preassembled unit 50. For this reason, the only step then necessary is to attach this unit 50 to the connection point 12 of the lock housing 11.

The elastic elements 40 are a component of a profiled structure 41 of elastomeric material, which is to be referred to below in brief as the “elastomer structure”. The elastomer structure 41 has essentially the form of a frame 42. After assembly, the frame opening 43 of this structure serves as a pass-through for the motor elements 22, 23, namely, an output shaft 23 and a brush holder 22, which project out from the motor housing 21, as can be seen in FIG. 2.

So that it can be attached, the motor housing 21 has a flange 24. The previously mentioned unit 50 is created in that the frame 42 has a recess to accept the flange 24. The front surface 25 and the back 26 surface of the flange 24 are covered by elements 45, which are formed as integral parts of the elastomeric material of the frame 42. The fastening means 30 act on these elements. After assembly, the unit shown in FIG. 2 has a top surface 51 and a bottom surface 52 of elastomeric material on opposite sides of the motor flange 24.

As can be seen best in FIG. 4, the fastening means 30 consist of a bushing 31 and a fastening pin 32 passing through the interior 33 of the bushing. This pin can be a screw or a rivet. This fastening pin 32 is provided at one end with a head 34. The elastomeric elements 45 have openings 47, each of which is aligned with a similar opening 27 in the flange 24 of the motor housing 21. These elastomeric elements 45 are seated at the beginnings and ends of tabs 46, as can be seen in FIG. 2. In the assembled state, as shown in FIG. 4, the tabs 48 are folded over, so that the elastomeric elements 45 are located on both sides of the motor flange 24. As can be seen in FIG. 4, the tabs 48 thus function as film hinges 46. All the openings 27, 47 are now aligned with each other and can accept the fastening means 30.

### LIST OF REFERENCE NUMBERS

10 lock
11 lock housing of 10
12 connection point on 11 for 20
13 hatch, rear hatch
14 mating profiling, receptacles in 11 for 49
15 hole in 11
16 threaded socket in 11 for 37
20 motor
21 motor housing of 20
22 brush holder of 20
23 output shaft of 20
24 flange of 21
25 front surface of 24
26 back surface of 24
27 opening in 24
30 fastening means
31 bushing of 30
32 fastening pin of 30
33 interior of bushing 31, inside surface of 31
34 head of pin 32
35 one end of bushing 31, support end of 31
36 other end of bushing 31, stop end of 31
37 end of pin 32
40 elastic element
41 elastomer structure of 40
42 frame of 41

1. A motor-actuated lock (10) for doors or hatches (13) of vehicles,
with a lock housing (11), which holds the elements of the lock and which is seated on the door or hatch (13) or on a part of the vehicle body next to the door or hatch (13);
with a motor (20) for actuating the lock elements, the elements of the motor being installed in a motor housing (21);
with a connection point (12) on the lock housing (11) for the motor housing (21); and
with fastening means (30), which hold the motor housing (21) on the lock housing (11),
wherein
elastic elements (40) are provided on all the connection points (12) between the motor housing (21) and the lock housing (11);
where the elastic elements (40) are a component of a profiled structure (41) consisting of elastomeric material, which is a designed as a one-piece part and is therefore to be called the elastomer structure (41);
where the elastomer structure (41) can be preassembled with the motor housing (21) to form a unit (50); and
where the fastening means (30) act on the elastic elements (40) of the elastomer structure (41).

2. A lock according to claim 1, wherein the motor housing (21) has a flange (24), by which the motor housing can be attached; and
where the elastomer structure (41) has a recess to accept the flange (24) and can be preassembled with the motor housing (21) to form a unit (50).

3. A lock according to claim 1, wherein the elastic elements (40) of the elastomer structure (41) consist of elements (45) which cover the front surface (25) and the back surface (26) of the flange (24).

4. A lock according to claim 1, wherein the elastomer structure (41) has a frame, and
where after assembly, the opening (43) in the frame (42) serves as a pass-through for a brush holder (22) and/or an output shaft (23) of the motor (20).

5. A lock according to claim 1, wherein the top surface (51) and/or the bottom surface (52) of the elastomer structure (41) or of its frame (42) on the one side and the flange (24) of the motor housing (21) and/or the connection point (12) of the lock housing (11) on the other side have profilings (14, 49), which serve to position the motor housing (21) on the lock housing (11) and/or to align the motor housing (21) with respect to the elastomer structure (41) or the frame (42) in the unit (50).

6. A lock according to claim 5, wherein the profilings consist of locating pins (49) on one side on the elastomer structure (41) or its frame (42) and of receptacles (14) in the lock housing (11) and/or in the flange (24) of the motor housing (21) on the other side.

7. A lock according to claim 1, wherein the elastomer structure (41) or the elastomeric elements (45) and the flange (24) of the motor housing (21) have openings (27, 47), through which the fastening means (30) can extend and thus exert their fastening function;
where the fastening means (30) consist of a bushing (31) and a fastening pin (32) extending through the interior (33) of the bushing, the pin being a screw or a rivet with a head (34) at one end; and
where after assembly, the openings (27, 47) hold the bushing (31).

8. A lock according to claim 7, wherein one end (35) of the bushing is supported against the connection point (12) of the lock housing (11) and functions as a support end,
whereas the head (34) of the pin rests against the other end of the bushing, which thus functions as a stop end; and
where the bottom end (37) of the fastening pin (32) is anchored in the lock housing (11).

9. A motor according to claim 8, wherein, after assembly, there is a radial gap essentially all the way around between the fastening pin (32) and the inside surface (33) of the bushing (31).

10. (Currently lock according to claim 8, wherein the axial length of the bushing (31) between stop end (36) and the support end (35) is long enough to ensure that
after assembly, the fastening pin (32) will not exert any clamping action on the elastomer structure (41) or the frame (42).

11. A lock according to claim 1, wherein the elastomer structure (41) or the frame (42) has tabs (48) of elastomeric material in the peripheral area; and
where after assembly, the tabs (48) are folded over (46) on both sides of the flange (34) of the motor housing.

12. A lock according to claim 1, wherein the lock housing (11) has a hole (15) in the area of the connection point (12), this hole serving as a pass-through for an output shaft (23) of the motor (20) after assembly;
where after assembly, a ring-shaped body (53) of elastomeric material is seated in the hole (15); and
where the ring-shaped body (53) serves to seal the hole (15) and/or to guide the output shaft (23) of the motor (20).

13. A lock according to claim 12, wherein the ring-shaped body (53) is designed as an integral part of the elastomer structure (41) or its frame (42).

14. A lock according to claim 13, wherein the ring-shaped body (53) is connected to the elastomer structure (41) or to the frame (42) by axial and/or radial webs.
